(19) United States
(12) Patent Application Publication
(10) Pub. No.: US 2017/0194091 A1
(43) Pub. Date: Jul. 6, 2017

(54) SATURATION RESISTANT ELECTROMAGNETIC DEVICE

(71) Applicant: The Boeing Company, Chicago, IL (US)

(72) Inventor: James L. Peck, JR., Huntington Beach, CA (US)

(21) Appl. No.: 14/988,318

(22) Filed: Jan. 5, 2016

(51) Int. Cl. H01F 27/32

(52) U.S. Cl. CPC H01F 27/324

(57) ABSTRACT

A saturation resistant electromagnetic device may include a core in which a magnetic flux is generable and an opening through the core. A spacer may be disposed within the opening and may extend through the core. The spacer may define a channel through the core. A primary conductor winding may be received in the channel of the spacer and may extend through the core. An electric current flowing through the primary conductor winding generates a magnetic field about the primary conductor winding. The magnetic field includes electromagnetic energy. The spacer may include a configuration to absorb a predetermined portion of the electromagnetic energy and a remaining portion of the electromagnetic energy is absorbed by the core to generate a magnetic flux flow in the core.

### FIELD

The present disclosure relates to electromagnetic devices, such as electrical transformers and inductors, and more particularly to a saturation resistant electromagnetic device, such as a saturation resistant inductor, transformer or similar device.

### BACKGROUND

Electromagnetic devices, such as inductors and transformers are used in many electrical circuits. For example, electric inductors are used in many circuits for the suppression or filtering of noise. Inductors may also be used for shaping electrical waveforms for particular applications. In high current direct current circuits, an inductor or set of inductors connected in series may approach saturation by a magnetic core of each inductor absorbing or receiving nearly a maximum amount of electromagnetic energy that the magnetic core is capable of absorbing. The electromagnetic energy being generated by the electric current flowing through the conductor winding or windings of each inductor. A significant portion of the inductance and efficiency of operation of the inductor is lost as the magnetic core of the inductor approaches saturation or becomes saturated. Accordingly, there may be a need to prevent saturation of a magnetic core of an inductor under some circumstances. Additionally, inductors may be heavy, large components because of the magnetic cores. Any reduction of the weight of inductors may be advantageous in some applications, for example in components onboard vehicles, such as aircraft or spacecraft, where a reduction in weight may result in fuel savings and reduced operating costs.

### SUMMARY

In accordance with an embodiment, a saturation resistant electromagnetic device may include a core in which a magnetic flux is generable and an opening through the core. The saturation resistant electromagnetic device may also include a spacer disposed within the opening and extending through the core. The spacer may define a channel through the core. The saturation resistant electromagnetic device may also include a primary conductor winding received in the channel of the spacer and extending through the core. An electrical current flowing through the primary conductor winding generates a magnetic field about the primary conductor winding. The magnetic field includes electromagnetic energy. The spacer includes a configuration to absorb a predetermined portion of the electromagnetic energy and a remaining portion of the electromagnetic energy is absorbed by the core to generate a magnetic flux flow in the core.

In accordance with another embodiment, a saturation resistant electromagnetic device may include a core in which a magnetic flux is generable and an opening through the core. A cross-section of the opening may define an elongated slot. The saturation resistant electromagnetic device may also include a spacer disposed within the opening and extending through the core. The spacer may define a channel through the core. A cross-section of the channel may define an elongated aperture. The saturation resistant electromagnetic device may also include a primary conductor winding received in the channel of the spacer and extending through the core. An electric current flowing through the primary conductor winding generates a magnetic field about the primary conductor winding. The magnetic field includes electromagnetic energy. The spacer includes a configuration to absorb a predetermined portion of the electromagnetic energy and a remaining portion of the electromagnetic energy is absorbed by the core to generate a magnetic flux flow in the core.

In accordance with a further embodiment, a method for preventing saturation of an electromagnetic device may include providing a core in which a magnetic flux is generable. The method may also include disposing a spacer within an opening in the core and extending the spacer through the core. The spacer may define a channel through the core. The method may additionally include extending a primary conductor winding through the channel of the spacer and extending the primary conductor winding through the core. The method may further include passing an electric current through the primary conductor winding to generate a magnetic field about the primary conductor winding. The magnetic field includes electromagnetic energy. The spacer includes a configuration to absorb a predetermined portion of the electromagnetic energy and a remaining portion of the electromagnetic energy is absorbed by the core to generate a magnetic flux flow in the core.

In accordance with another embodiment or any of the previous embodiments, the configuration of the spacer may be adapted to decrease a magnetic coupling between the primary conductor winding and the core by a preset amount that prevents saturation of the core. The configuration of the spacer may define a magnetic flux resistive and absorbing volume.

In accordance with another embodiment or any of the previous embodiments, the spacer may include a non-magnetic material or the spacer may include a material that includes a magnetic flux resistive property or a magnetic flux absorbing property. The spacer may be impregnated with a selected concentration of electrically conductive or semi-conductive particles that causes a certain absorption of the magnetic flux and conversion of the magnetic flux to heat energy that prevents saturation of the core. The electrically conductive or semi-conductive particles may include at least one of carbon particles, aluminum particles and iron particles. The spacer may also include a predetermined thickness between an outer wall that abuts an inner surface of the core and an inner wall that defines the channel.

### BRIEF DESCRIPTION OF THE DRAWINGS

The following detailed description of embodiments refers to the accompanying drawings, which illustrate specific embodiments of the disclosure. Other embodiments having different structures and operations do not depart from the scope of the present disclosure.

FIG. 1 is an end perspective view of an example of a saturation resistant electromagnetic device in accordance with an embodiment of the present disclosure.

FIG. 2 is an end view of an example of a saturation resistant electromagnetic device in accordance with another embodiment of the present disclosure.

FIG. 3 is an end view of an example of a saturation resistant electromagnetic device in accordance with a further embodiment of the present disclosure.

FIG. 4A is an end view of an example of a saturation resistant electromagnetic device in accordance with another embodiment of the present disclosure.

FIG. 4B is a block schematic diagram of an example of a saturation resistant electrical circuit including the saturation resistant electromagnetic device of FIG. 4A.

FIG. 5 is a flow chart of an example of a method for preventing saturation of an electromagnetic device in accordance with an embodiment of the present disclosure.

### DETAILED DESCRIPTION

The following detailed description of embodiments refers to the accompanying drawings, which illustrate specific embodiments of the disclosure. Other embodiments having different structures and operations do not depart from the scope of the present disclosure. Like reference numerals may refer to the same element or component in the different drawings.

Certain terminology is used herein for convenience only and is not to be taken as a limitation on the embodiments described. For example, words such as “proximal”, “distal”, “top”, “bottom”, “upper,” “lower,” “left,” “right,” “horizontal,” “vertical,” “upward,” and “downward”, etc., merely describe the configuration shown in the figures or relative positions used with reference to the orientation of the figures being described. Because components of embodiments can be positioned in a number of different orientations, the directional terminology is used for purposes of illustration and is in no way limiting. It is to be understood that other embodiments may be utilized and structural or logical changes may be made without departing from the scope of the present disclosure. The following detailed description, therefore, is not to be taken in a limiting sense, and the scope of the present disclosure is defined by the appended claims.

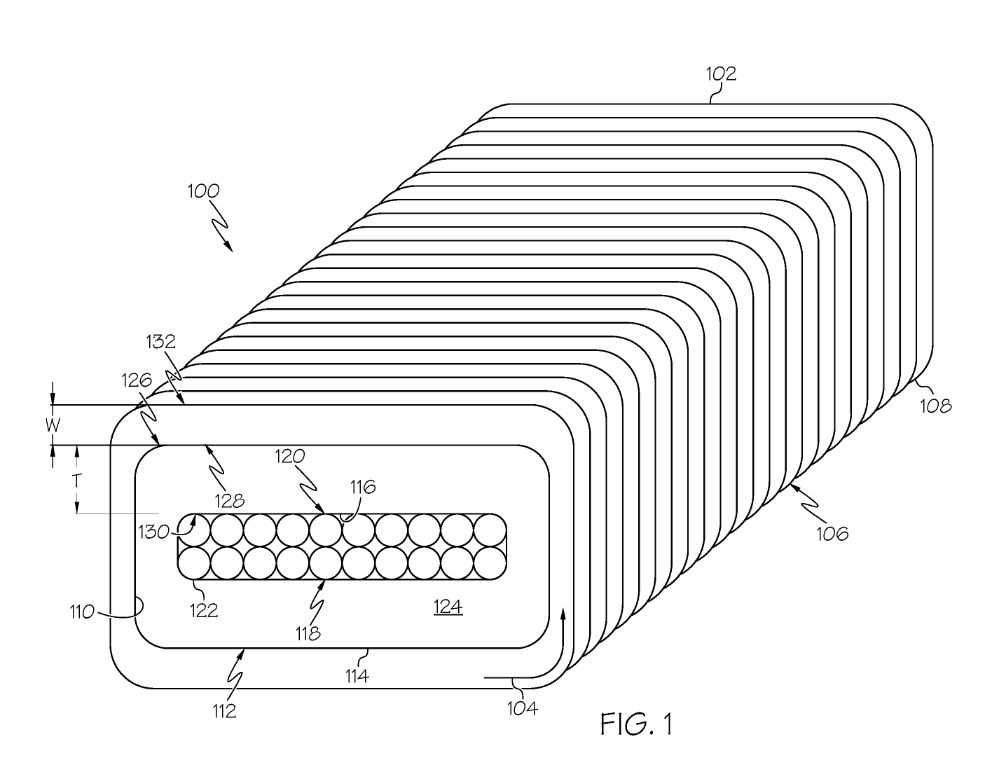

FIG. 1 is an end perspective view of an example of a saturation resistant electromagnetic device 100 in accordance with an embodiment of the present disclosure. The saturation resistant electromagnetic device 100 illustrated in FIG. 1 may be configured as a linear inductor or transformer. The saturation resistant electromagnetic device 100 may include a core 102 in which a magnetic flux 104 may be generable flowing in the core 102 as illustrated by the arrow. In the exemplary embodiment illustrated in FIG. 1, the core 102 may be an elongated core including a laminated structure 106. The laminated structure 106 may include a plurality of plates 108 or laminations stacked on one another or disposed adjacent one another. The plates 108 may be made from a silicon steel alloy, a nickel-iron alloy or other metallic material capable of generating a magnetic flux 104 similar to that described herein. For example, the core 102 may be a nickel-iron alloy including about 20% by weight iron and about 80% by weight nickel. The plates 108 may be substantially square or rectangular, or may have some other geometric shape depending on the application of the saturation resistant electromagnetic device 100 and the environment where the electromagnetic device 100 may be located. For example, the substantially square or rectangular plates 108 may be defined as any type of polygon to fit a certain application. In another embodiment, the core 102 may include a one-piece structure.

An opening is formed through each of the plates 108 and the openings are aligned to form an opening 110 or passage through the core 102 when the plates 108 are stacked on one another with the plate openings in alignment with one another. The opening 110 or passage may be formed in substantially a center or central portion of the core 102 and may extend substantially perpendicular to a plane defined by each plate 108 of the stack of plates 108 or laminates. In another embodiment, the opening 110 may be formed off center from a central portion of the core 102 in the planes defined by each of the plates 108 for purposes of providing a particular magnetic flux or to satisfy certain constraints. A cross-section of the opening 110 may define an elongated slot 112 including a length greater than a height of the opening 110.

A spacer 114 may be disposed within the opening 110 and may extend through the core 102. The spacer 114 may define a channel 116 through the core 102. A cross-section of the channel 116 may define an elongated aperture 118 including a length greater than a height of the channel 116.

A primary conductor winding 120 may be received in the channel 116 and may extend through the core 102 perpendicular the plane of each of the plates 108. In the exemplary embodiment illustrated in FIG. 1, the primary conductor winding 120 includes a plurality of electrical conductors 122 or wires. The primary conductor winding 120 may include an electrical conductor or conductors that pass or are wound through the channel 116 multiple times. In another embodiment, the primary conductor winding 120 may be a single electrical conductor. For example, the primary conductor winding 120 may be a ribbon shaped electrical conductor.

An electric current flowing through the primary conductor winding 120 generates a magnetic field about each of the electrical conductors 122 or around the primary conductor winding 120. The magnetic field includes electromagnetic energy. The spacer 114 includes a configuration 124 to absorb a predetermined portion of the electromagnetic energy or magnetic flux 104 and a remaining portion of the electromagnetic energy or magnetic flux 104 is absorbed by the core 102 to generate a magnetic flux flow in the core 102. The configuration 124 of the spacer 114 allows the predetermined portion of the electromagnetic energy or magnetic flux absorbed by the space 114 to be controlled for preventing saturation of the core 102 or to make the electromagnetic device 100 more resistant to saturation. Saturation of the core 102 occurring in response to an electrical current flowing through the primary conductor winding 120 generating a maximum or more than a maximum amount of electromagnetic energy or magnetic flux than the core 102 is capable of absorbing or receiving.

The spacer 114 may include a predetermined thickness “T” between an outer wall 126 of the spacer 114 that abuts an inner surface 128 of the core 102 and an inner wall 130 of the spacer 114 that defines the channel 116. In accordance with an embodiment, the thickness “T” of the spacer 114 may be greater than or equal to a thickness “W” of the core 102 between the inner surface 128 of the core 102 and an outer surface 132 of the core 102. For example, the thickness “T” of the spacer 114 may be about twice the thickness “W” of the core 102. Referring also to FIG. 2, FIG. 2 is an end view of an example of a saturation resistant electromagnetic device 200 in accordance with another embodiment of the present disclosure. The saturation resistant electromagnetic device 200 may be similar to the saturation resistant electromagnetic device 100 in FIG. 1 except the thickness “T” of the spacer 114 is less than the thickness “W” of the core 102. In another embodiment, the thickness “T” of the spacer 114 may be equal to the thickness “W” of the core 102.

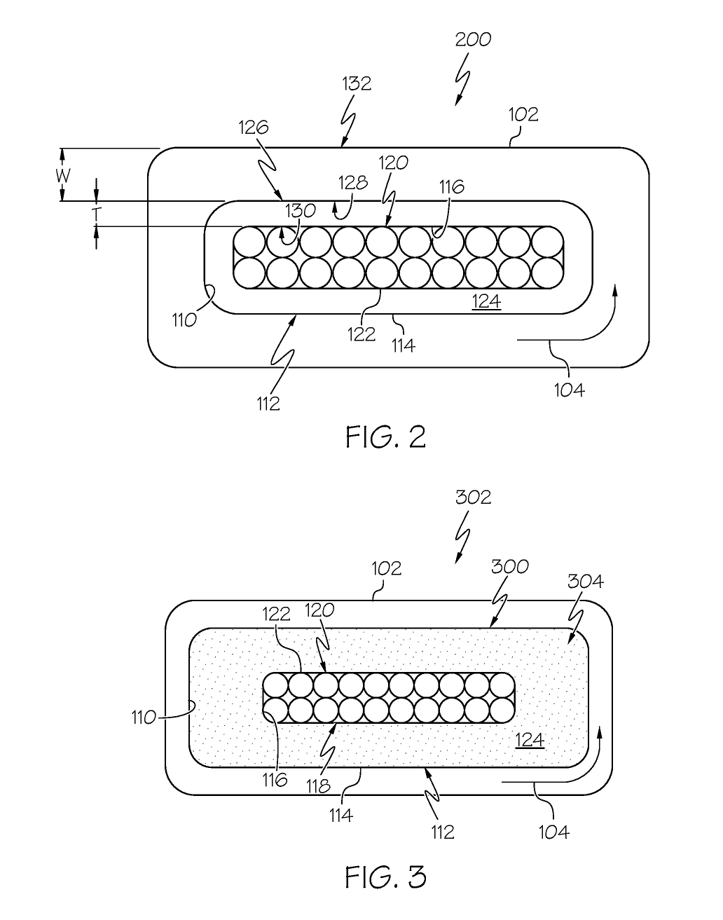

The configuration 124 of the space 114 may be adapted to decrease a magnetic coupling between the primary conductor winding 120 and the core 102 by a preset amount that prevents saturation of the core 102 or may reduce the magnitude of electromagnetic energy or magnetic flux that may cause saturation of the core 102. In one embodiment, the spacer 114 may include a non-magnetic or a non-ferrous material. In another embodiment, such as that illustrated in FIG. 3, the configuration 124 of the spacer 114 may define a magnetic flux resistive and absorbing volume 300. Referring also to FIG. 3, FIG. 3 is an end view of an example of a saturation resistant electromagnetic device 302 in accordance with a further embodiment of the present disclosure. The saturation resistant electromagnetic device 302 may be similar to the saturation resistant electromagnetic device 100 of FIG. 1 except the spacer 114 may include a configuration 124 that defines the magnetic flux resistive and absorbing volume 300. The spacer 114 may include a material that includes a magnetic flux resistive property or properties and/or a magnetic flux absorbing property or properties. For example, the spacer 114 may be impregnated with a selected concentration of electrically conductive or semi-conductive particles 304 that may cause a certain absorption of the electromagnetic energy or magnetic flux 104 and conversion of the electromagnetic energy or magnetic flux 104 to heat energy to prevent saturation of the core 102. The selected concentration of electrically conductive or semi-conductive particles 304 may also be a chosen type of material. Examples of type of materials that may be used for the particles 304 may include but is not necessarily limited to carbon particles, aluminum particles, iron particles or other particles that may provide a predetermined absorption of the electromagnetic energy or magnetic flux 104. Accordingly, a concentration of the electrically conductive or semi-conductive particles 304 and type of particles may be controlled or adjusted to control an amount of electromagnetic energy or magnetic flux 104 absorbed by spacer 114.

A higher concentration of electrically conductive or semi-conductive particles 304 in the spacer 114 will result in a higher absorption of the electromagnetic energy or magnetic flux 104 in the spacer 114 and less electromagnetic energy or magnetic flux 104 being received by the core 102. Accordingly, the concentration and type of material of the electrically conductive or semi-conductive particles 304 may be adjusted when forming the spacer 114 to provide a desired or designed absorption of the electromagnetic energy or magnetic flux 104 in the spacer 114 and/or a particular reduction of the electromagnetic energy entering the core 104 and magnitude of the magnetic flux 104 flowing in the core 102 to prevent saturation based on a particular input voltage and current applied to the primary conductor winding. A magnetic field density is less at the inner surface 128 of the core 102 while a total magnetic flux 104 generated by the current in the primary conductor winding 120 is unchanged. The core 102 of the saturation resistant electromagnetic device 302 will be saturated or absorb a maximum magnitude of electromagnetic energy or magnetic flux at a higher current flowing through the primary conductor winding 120 as a result of the spacer 114 and based on the configuration 124 of the spacer 114 as described herein than without the spacer 114.

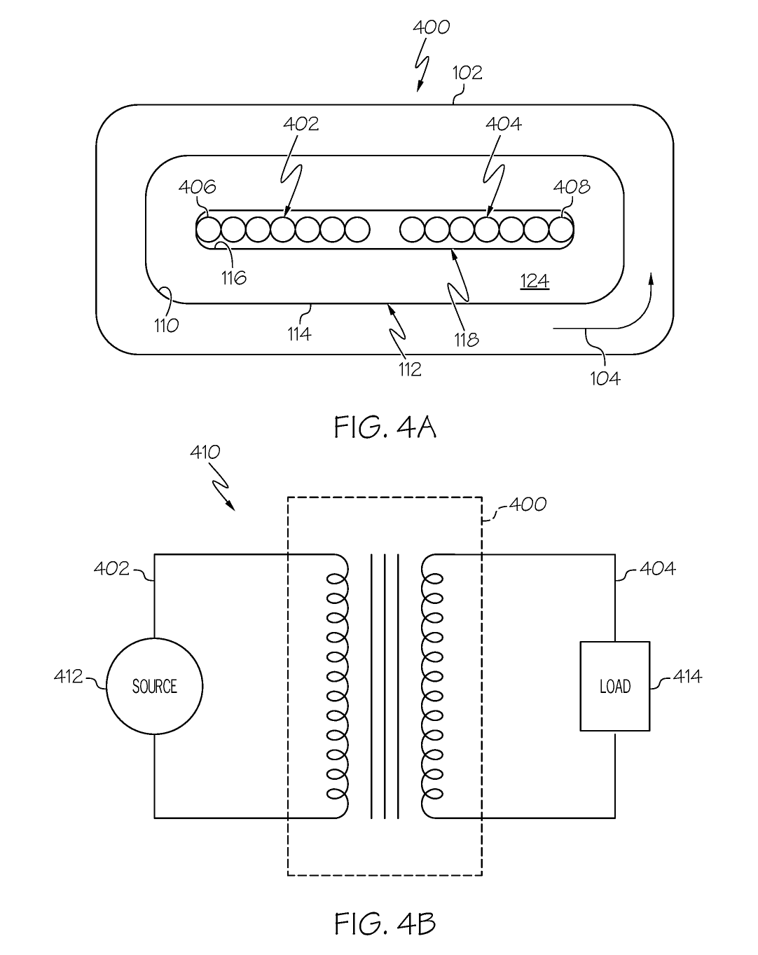

FIG. 4A is an end view of an example of a saturation resistant electromagnetic device 400 in accordance with another embodiment of the present disclosure. The saturation resistant electromagnetic device 400 may be the same as the saturation resistant electromagnetic device 100, 200 or 300 except the saturation resistant electromagnetic device 400 may be configured as a transformer and may include a primary conductor winding 402 and a secondary conductor winding 404 through the channel 116 and the core 102. The primary conductor winding 402 may include a plurality of electrical conductor wires 406 and the secondary conductor winding 404 may also include a plurality of electrical conductor wires 408. The plurality of electrical conductor wires 406 of the primary conductor winding 402 may be disposed adjacent one another in the channel 116. The plurality of electrical conductor wires 408 of the secondary conductor winding may also be disposed adjacent one another in the channel 116. The primary conductor winding 402 and the secondary conductor winding 404 may each be disposed adjacent one another in the channel 116.

While the electrical conductor wires 406 and 408 are shown in the exemplary embodiment in FIG. 4A as having a circular cross-section. Electrical conductor wires having other cross-sectional shapes may also be used, such as for example square or rectangular cross-sections similar to that described in U.S. Pat. No. 9,159,487, entitled “Linear Electromagnetic Device,” which is assigned to the same assignee as the present application and is incorporated herein by reference.

Referring also to FIG. 4B, FIG. 4B is a block schematic diagram of an example of an electrical circuit 410 including the saturation resistant electromagnetic device 400 of FIG. 4A. The primary conductor winding 402 may be electrically connected to a source 412 of electrical power and the secondary conductor winding 404 may be connected to a load 414.

The exemplary electromagnetic devices 100, 200, 302 and 400 in FIGS. 1-4 provide a new inductor or transformer designs that are lighter in weight because a portion of the core 102 may be replaced by the lighter weight spacer 114 and controllably small inductance values may be achieved using the spacer 114 and inexpensive manufacturing techniques. The spacer 114 including a non-magnetic material inserted between the primary conductor winding 120 and the core 102 provides a separation distance between the primary conductor winding 120 and the inner surface 128 of the core 102 that corresponds to the thickness “T” of the spacer 114. The separation distance reduces the inductance in a controllable way to provide a lower effective inductance of the electromagnetic device 100, 200, 302 or 400. With a lower inductance and lower saturation, the electromagnetic device 100, 200, 302 or 400 may responds better to noise signals.

As described herein, in another embodiment, the spacer 114 may be impregnated with electrically conductive or semi-conductive particles 304 to further reduce the inductor efficiency. For example, a 30 ampere Direct Current (A DC) signal may saturate a large portion of the core 102 while a smaller portion is not saturated. If noise is added on top of the 30 A DC signal, the core 102 may not respond properly to noise due to the saturation. With the spacer 114, the core 102 may response to the noise. The energy density at the inner surface 128 of the core 102 is reduced by the spacer 114 but the total magnetic flux 104 remains the same. Because the energy density at the inner surface 128 of the core 102 is lower, the amount of penetration of the electromagnetic energy or magnetic flux 104 into the core 102 is less. Less material is needed for the electromagnetic device 100, 200, 302 or 400 and a lower inductance can be made. Additionally, the electromagnetic device 100, 200, 302 or 400 may be lighter due to replacement of the otherwise persistently saturated portion of the core 102 by the spacer 114. Embodiments of the electromagnetic devices 100, 200, 302 and 400 described herein enables smaller, lighter weight inductors that can accomplish the induction requirements for higher current filters where the high current may saturate or nearly saturate the core 102 making the device less effective at filtering signals.

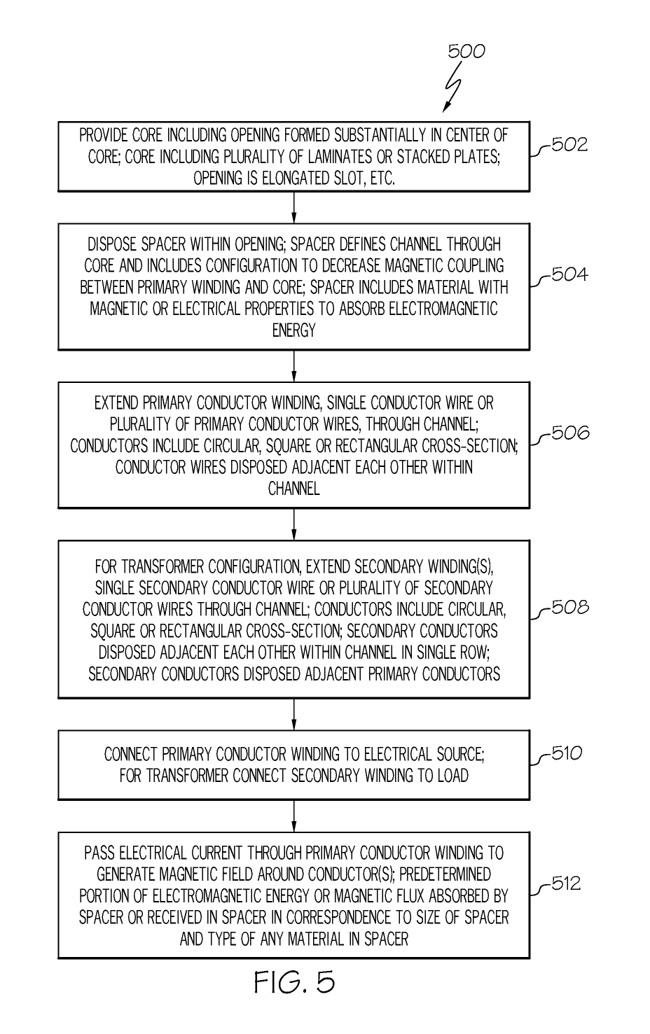

FIG. 5 is a flow chart of an example of a method 500 for preventing saturation of an electromagnetic device in accordance with an embodiment of the present disclosure. In block 502, a core may be provided in which a magnetic flux may be generated. The core may be an elongated core, similar to the exemplary core 102 in FIG. 1, and may include a laminated structure having a plurality of plates or laminates stacked on one another. In another embodiment, the core may be formed from a one-piece structure. An opening may be formed through the core. The opening may be formed substantially in a center of the core and a cross-section of the opening may define an elongated slot through the core.

In block 504, a spacer may be disposed within an opening in the core and extend through the core. The spacer may define a channel through the core. The spacer may include a configuration adapted to decrease magnetic coupling between a primary winding and the core of the saturation resistant electromagnetic device by a preset amount that prevents saturation of the core. The configuration of the spacer may include a material in the spacer with a magnetic flux resistive property or a magnetic flux absorbing property. For example, the configuration of the spacer may include impregnating the spacer with a selected concentration of electrically conductive or semi-conductive particles that causes a certain absorption of the magnetic flux and conversion of the magnetic flux to heat energy that prevents saturation of the core.

In block 506, a primary conductor winding may be extended through the channel of the spacer and through the core. The primary conductor winding may be a single conductor wire or plurality of primary conductor wires through the channel. The conductors may include a predetermined cross-section. For example, the conductors may have a circular, square, rectangular or other cross-section depending upon the design and/or application of the saturation resistant electromagnetic device. The conductor wires may be disposed adjacent one another in a single row within the channel or may be arranged in some other configuration.

In block 508, for a transformer configuration of the saturation resistant electromagnetic device, a secondary winding or windings may be extended through the channel. The secondary conductor winding or windings may each include a single secondary conductor wire or a plurality of secondary conductor wires extending through the channel. The secondary conductor wire or wires may include a predetermined cross-section, for example, a circular, square, rectangular or other cross-section. The secondary conductor wires made be disposed adjacent each other within the channel in a single row or in some other arrangement. The secondary conductor winding may be disposed adjacent the primary conductor winding within the channel.

In block 510, the primary conductor winding may be connected to a source of electrical power. If the saturation resistant electromagnetic device is configured as a transformer, the secondary conductor winding may be connected to a load.

In block 512, an electric current may be passed through the primary conductor winding to generate a magnetic field about the primary conductor winding. The magnetic field includes electromagnetic energy. As previously described, the spacer includes a configuration to absorb a predetermined portion of the electromagnetic energy or magnetic flux and a remaining portion of the electromagnetic energy is absorbed by the core to generate a magnetic flux flow in the core. The predetermined portion of electromagnetic energy or magnetic flux absorbed by the spacer or received within the spacer is based on the configuration of the spacer and may correspond to a size or thickness of the spacer between the channel and an inner surface of the core and type of material, if any, with electrical or magnetic properties within the spacer to absorb the electromagnetic energy and covert it to heat energy. The spacer, based on the configuration, may prevent the core of the saturation resistant electromagnetic device from being saturated or absorbing a maximum magnitude of magnetic flux at a higher current flowing through the primary conductor winding.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to embodiments of the invention in the form disclosed. Many modifications and variations will be apparent to those of ordinary skill in the art without departing from the scope and spirit of embodiments of the invention. The embodiment was chosen and described in order to best explain the principles of embodiments of the invention and the practical application, and to enable others of ordinary skill in the art to understand embodiments of the invention for various embodiments with various modifications as are suited to the particular use contemplated.

Although specific embodiments have been illustrated and described herein, those of ordinary skill in the art appreciate that any arrangement which is calculated to achieve the same purpose may be substituted for the specific embodiments shown and that embodiments of the invention have other applications in other environments. This application is intended to cover any adaptations or variations of the present invention. The following claims are in no way intended to limit the scope of embodiments of the invention to the specific embodiments described herein.

What is claimed is:

1. A saturation resistant electromagnetic device (100, 200, 302, 400), comprising:
a core (102) in which a magnetic flux (104) is generable;
an opening (110) through the core;
a spacer (114) disposed within the opening and extending through the core, the spacer defining a channel (116) through the core; and
a primary conductor winding (120) received in the channel of the spacer and extending through the core, wherein an electric current flowing through the primary conductor winding generates a magnetic field about the primary conductor winding, the magnetic field comprising electromagnetic energy and the spacer comprising a configuration (124) to absorb a predetermined portion of the electromagnetic energy and a remaining portion of the electromagnetic energy being absorbed by the core to generate a magnetic flux flow in the core.

2. The saturation resistant electromagnetic device of claim 1, wherein the configuration of the spacer is adapted to decrease a magnetic coupling between the primary conductor winding and the core by a preset amount that prevents saturation of the core.

3. The saturation resistant electromagnetic device of claim 1, wherein the configuration of the spacer defines a magnetic flux resistive and absorbing volume (300).

4. The saturation resistant electromagnetic device of claim 1, wherein the spacer comprises a non-magnetic material.

5. The saturation resistant electromagnetic device of claim 1, wherein the spacer comprises a material that includes a magnetic flux resistive property or a magnetic flux absorbing property.

6. The saturation resistant electromagnetic device of claim 1, wherein the spacer is impregnated with a selected concentration of electrically conductive or semi-conductive particles (304) that causes a certain absorption of the magnetic flux and conversion of the magnetic flux to heat energy that prevents saturation of the core.

7. The saturation resistant electromagnetic device of claim 6, wherein the electrically conductive or semi-conductive particles comprise at least one of carbon particles, aluminum particles and iron particles.

8. The saturation resistant electromagnetic device of claim 1, wherein the spacer comprises a predetermined thickness (T) between an outer wall (126) that abuts an inner surface (128) of the core and an inner wall (130) that defines the channel.

9. The saturation resistant electromagnetic device of claim 8, wherein the predetermined thickness of the spacer is greater than or equal to a thickness of the core.

10. The saturation resistant electromagnetic device of claim 1, wherein a magnetic field density is less at an inner surface of the core while a total magnetic flux generated by the current in the primary conductor winding is unchanged.

11. The saturation resistant electromagnetic device of claim 1, wherein the core is an elongated core comprising one of a one-piece structure and a laminated structure (106) including a plurality of plates (108) stacked on one another.

12. A saturation resistant electromagnetic device (100, 200, 302, 400), comprising:
a core (102) in which a magnetic flux is generable;
an opening (110) through the core, a cross-section of the opening defining an elongated slot (112);
a spacer (114) disposed within the opening and extending through the core, the spacer defining a channel (116) through the core, a cross-section of the channel defining an elongated aperture (118); and
a primary conductor winding (120) received in the channel of the spacer and extending through the core, wherein an electric current flowing through the primary conductor winding generates a magnetic field about the primary conductor winding, the magnetic field comprising electromagnetic energy and the spacer comprising a configuration (124) to absorb a predetermined portion of the electromagnetic energy and a remaining portion of the electromagnetic energy being absorbed by the core to generate a magnetic flux flow in the core.

13. The saturation resistant electromagnetic device of claim 12, wherein the configuration of the spacer is adapted to decrease a magnetic coupling between the primary conductor winding and the core by a preset amount that prevents saturation of the core.

14. The saturation resistant electromagnetic device of claim 13, wherein the spacer comprises a non-magnetic material.

15. The saturation resistant electromagnetic device of claim 13, wherein the spacer comprises a material that includes a magnetic flux resistive property or a magnetic flux absorbing property.

16. The saturation resistant electromagnetic device of claim 15, wherein the spacer is impregnated with a selected concentration of electrically conductive or semi-conductive particles (304) that causes a certain absorption of the magnetic flux and conversion of the magnetic flux to heat energy that prevents saturation of the core.

17. A method (500) for preventing saturation of an electromagnetic device, comprising:
providing a core in which a magnetic flux is generable (502);
disposing a spacer within an opening in the core and extending the spacer through the core, the spacer defining a channel through the core (504);
extending a primary conductor winding through the channel of the spacer and extending the primary conductor winding through the core (506); and
passing an electric current through the primary conductor winding to generate a magnetic field about the primary conductor winding (512), the magnetic field comprising electromagnetic energy and the spacer comprising a configuration to absorb a predetermined portion of the electromagnetic energy and a remaining portion of the electromagnetic energy being absorbed by the core to generate a magnetic flux flow in the core.

18. The method of claim 17, further comprising configuring the spacer to decrease a magnetic coupling between the primary conductor winding and the core by a preset amount that prevents saturation of the core.

19. The method of claim 18, wherein configuring the spacer comprises including a material in the spacer that includes a magnetic flux resistive property or a magnetic flux absorbing property.

20. The method of claim 19, wherein configuring the spacer comprises impregnating the spacer with a selected concentration of electrically conductive or semi-conductive particles (304) that causes a certain absorption of the magnetic flux and conversion of the magnetic flux to heat energy that prevents saturation of the core.
